(19) United States
(12) Patent Application Publication
(10) Pub. No.: US 2008/0154530 A1
(43) Pub. Date: Jun. 26, 2008

(54) Method for normalized test line limits with measurement uncertainty

(76) Inventors: David W. Murray, Windsor, CA (US); Kim Chung Thi Thanh, Rohnert Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/515,057

(22) Filed: Sep. 1, 2006

(51) Int. Cl. G06F 19/00; G06F 17/40

(52) U.S. Cl. 702/108; 702/127; 702/1; 702/182; 702/113; 702/117; 702/85; 702/187

(57) ABSTRACT

A method is provided for performing a diagnostic test on a piece of equipment, the equipment including a plurality of components and defining various pathways through respective subsets of the components, the equipment having an operator. The method comprises setting test limits, performing the test and obtaining test results, and determining whether the test results fall within the test limit. When the test results fall outside the test limits, it is determined whether the test limits are aligned. If not, then the test results are disregarded.

### BACKGROUND OF THE INVENTION

The present invention relates to diagnostic testing for electronic equipment.

Conventional diagnostic testing arrangements have involved coupling a test system, such as a production line UNIX™ workstation, to an instrument or piece of equipment to be tested. Troubleshooting software applications, in the form of BASIC™ or C™ language programs or shell scripts, etc., reside within the test system.

When such troubleshooting software applications are executed, the test system, and the instrument to be tested, communicate through a communication interface. For instance, many such troubleshooting applications use an IEEE 488 General Purpose Interface Bus (GPIB) connection between the UNIX™ workstation and the instrument.

It would be advantageous to employ standard network communications for such diagnostic testing, obviating the need for a diagnostic-specific interface such as the GPIB and allowing for remote testing. It would also be advantageous to execute diagnostic testing on-board the equipment to be tested.

### SUMMARY OF THE INVENTION

A method is provided for performing a diagnostic test on a piece of equipment, the equipment including a plurality of components and defining various pathways through respective subsets of the components, the equipment having an operator. The method comprises setting test limits, performing the test and obtaining test results, and determining whether the test results fall within the test limit. When the test results fall outside the test limits, it is determined whether the test limits are aligned. If not, then the test results are disregarded.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a block diagram of a system for performing embedded diagnostic tests on a piece of equipment containing an embodiment of the invention.

FIG. 2 is a high-level diagnostic testing procedure flowchart.

FIG. 3 is a flowchart showing a diagnostic testing procedure according to an embodiment of the invention.

### DETAILED DESCRIPTION

A system embodying the invention includes self-contained embedded diagnostics for a piece of electronic equipment. Among other fields, such a system may be employed in a measurement apparatus for radiofrequency (hereinafter “RF”) systems.

In such systems, it is desirable to be able to self-diagnose problems which can be solved by replacing sub-assemblies, cables, etc., without requiring the use of external test and measurement equipment. When such a problem is diagnosed, service personnel not necessarily requiring great expertise or training, can replace the problem component.

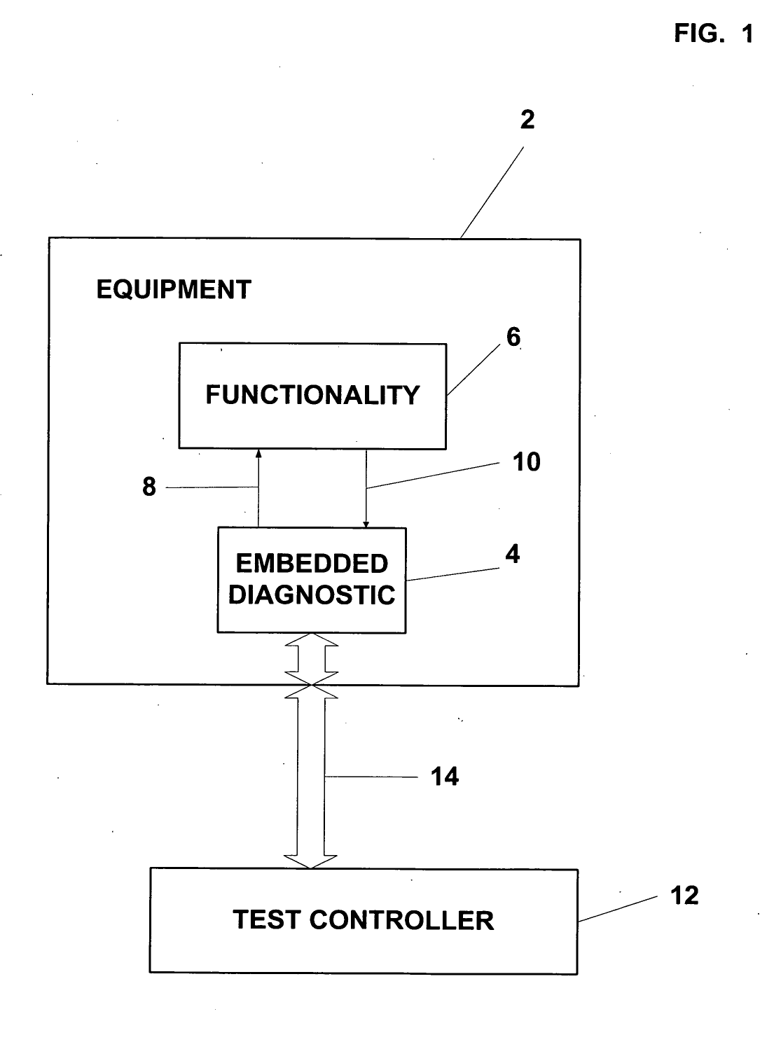

For instance, FIG. 1 is a schematic block diagram of a system in which a piece of equipment 2, which is to be tested, includes an embedded diagnostic apparatus 4. The equipment 2 has a general functionality 6, whose nature is not essential to the present invention but is characteristic of the type of equipment 2. The diagnostic apparatus 4 provides input stimulus signals to the functionality 6 through an input 8, and receives response signals through an output 10. Optionally, the diagnostic 4 can be controlled by an external test controller 12, through a communication link 14. Where the equipment 2 includes a standard interface, such as a WINDOWS™-based graphical interface, the test controller may perform a log-in procedure to run the embedded diagnostic 4.

In the discussion which follows, the term “indicted” will be used to describe a component, sub-assembly, etc., for which a problem has been diagnosed. Also, the terms “component” and “communication component” will be used interchangeably, to refer broadly and without limitation to any sub-assembly, cable, interface, component, etc., within a communications system, for which a fault may occur. The term “fault” will refer to any problem that is, or can be, isolated within a particular component of the communication system. Where a test identifies that a component is faulty, we say that the component is “indicted.” The terms “equipment”, “piece of equipment”, “instrument”, etc., are used interchangeably, without limitation, to refer to the equipment 2 of FIG. 1. Finally, the term “device under test” or “DUT” will be used to refer to the equipment to be tested.

The concepts of (ii) troubleshooting equipment to identify problems, and (ii) calibrating the equipment for optimum or threshold satisfactory and uniform performance, can overlap in the context of diagnostic testing, particularly testing using diagnostic tools embedded within the equipment. In particular, embedded diagnostic apparatus embodying the present invention may perform both the troubleshooting and calibration functions.

A piece of equipment, such as a spectrum analyzer, RF test and measurement equipment, etc., performs against a set of performance specifications (also called “test line limits” or “test limits”), and is calibrated so as to conform to those specifications, within a given tolerance. Where the calibration meets such tolerance, it is said that the equipment is “aligned.” The equipment is calibrated, i.e., aligned, at the factory prior to customer shipment. It is also possible to check alignment as the equipment is being used.

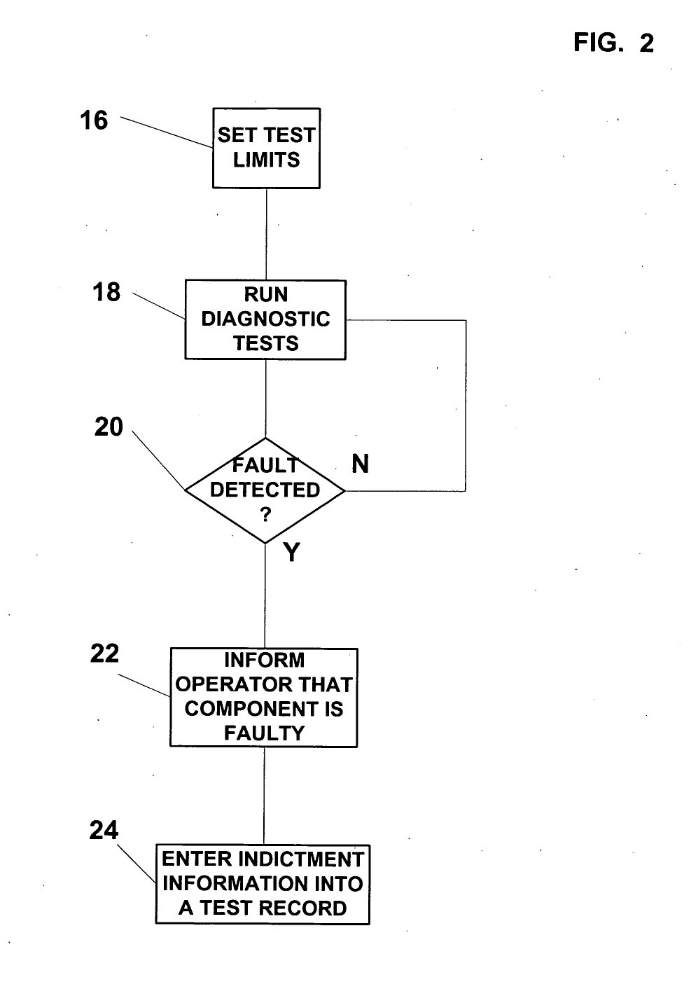

Consider, first, an example of a diagnostic process, as illustrated in the flowchart of FIG. 2. Test limits are set (16), either by factory calibration before product shipment, or as part of the user's maintenance or other operation of the equipment. The diagnostic tests are run (18), and it is determined (20) whether a fault in the equipment has been detected. The test (20) may include checking, from multiple tests, whether a particular component is indicated as being faulty. If no fault has been detected, then further testing (18), etc., is performed if and when appropriate. If there is a fault, then the operator is informed (22) of the fault so he/she can replace the faulty component. As appropriate, a test results report including an indictment, identifying the faulty component and giving diagnosis information, is entered into a test record (24). From the information in the indictment, the operator may choose to swap out a diagnosed faulty component, and install a replacement component. The faulty component may then be repaired on the spot, or sent back to the factory or a service center for repairs.

In one embodiment of the invention, alignment of test limits may also be verified, to address a situation where the test limits as set in (16) may not be adequate to accurately distinguish faults from correct operation. Test limits for different tests exercising faulty hardware are aligned, as discussed above. For instance, in a spectrum analyzer or RF communication device, such alignment may include scaling in amplitude or frequency.

Diagnosis of a faulty component is dependant on statistically identifying the most likely failing components indicted via pass/fail results, and scored/ordered as a function of component fail rate and function variability. Diagnosis of a faulty component can be based on a variety of factors. Unfortunately, however, it is not always easy to verify that a component is to be indicted, despite the fact that faults relating to it are detected. Consider an example of a situation in which a piece of equipment is subjected to a menu of 100 tests. Ten of the tests use a particular component, which is faulty. Each of these ten tests traces a different RF path through the instrument, all of which include the faulty component.

Diagnosis and indictment of the faulty component would be easiest if all ten of the tests which use the bad component fail. However, due to a variety of complex interactions, it may be that some will fail and others will pass. This is an inconclusive test result, which will degrade diagnosis performance, or even lead to incorrect indictment or exoneration of components.

Diagnostic test systems and methods embodying the invention reduce the likelihood of false passes or false fails, relative to conventional systems and methods. Tests of experimental embodiments of the invention have achieved performance levels of greater than 90% first time correct diagnoses.

Test stimulus signals are used, for instance, for firmware alignments which run automatically when the device under test needs them. A successful, accurate diagnostic test depends on (1) correct settings (also called “alignment”) of test limits, and (2) correct functioning of the equipment being tested, specifically correct functioning of components of the equipment that are in the equipment's pathway that the test stimulus signals are intended to exercise. (In a given piece of equipment, there will be various “pathways” running through sequences of components and interconnections of the equipment. An operational or test signal, such as an RF signal, runs through a pathway, and generally exercises the components within the pathway. Thus, a faulty component will tend to cause tests to show failures, where the tests involve signals running through pathways that include the faulty component.) If the stimulus signals designed or programmed into an embedded test system fail to meet, or due to changed conditions cease to meet, the expected performance, then confidence in the adequacy of the internal alignment is necessarily low.

Testing with misaligned test limits result in the device under test behaving inappropriately. The problem of this inappropriate behavior may be characterized as a form of aliasing.

As an aside, here is a general definition of “aliasing.” In statistics, signal processing, and related disciplines, the term “aliasing” refers to an effect that causes different continuous signals to become indistinguishable (or “aliases” of one another) when sampled. When this happens, the original signal cannot be uniquely reconstructed from the sampled signal. Aliasing can take place either in time (“temporal aliasing”), or in space (“spatial aliasing”).

For the purpose of the present invention, “aliasing” refers to test results that incorrectly may appear as either successes or failures, because they are relative to misaligned test limits.

A diagnostic performed by a system embodying the invention can indict an identified faulty component, failing component, or component deemed likely to fail or to have failed. Also, the particular nature of the fault or failure can be identified. Some embodiments of test systems maintain records, such as a list, or indicted components identified by the diagnostic testing procedure.

In a relatively simple testing scenario, the goal is simply to determine whether the equipment under test passes or fails the tests. Equipment which fails is removed, repaired and then retested. In a more sophisticated testing scenario employing embedded diagnostics, detected failures are recorded. In this type of scenario, each pass or fail has explicit meaning in terms of exonerating or indicting system hardware. Since there are a very large set of possible failure modes which affect system gains and alignment goodness, detecting and recording such meaningfully described failures presents considerable challenges and difficulties.

Where test limits are properly aligned, usually all the tests which exercise a faulty component come out as failures. Likewise, all tests that exercise pathways made up entirely of properly functioning components come out successfully.

A measurement technique for test development for embedded tests is provided, which can achieve the aforementioned test failures and successes, and mitigate the number and content of conflicting test results.

In an embodiment of the invention, test line limits are set, for alignments, for instance internal firmware alignments. When a test is run against an alignment which is found to fail the test line limits, then do not update the calibration value in the alignment table. This DUT was tested in production and worked at some time. The known good alignment data for the instrument should be held in memory to be employed on a per alignment basis when the DUT, sometime in the future fails one of its internal alignments. This prevents aliasing of alignment results due to bad hardware.

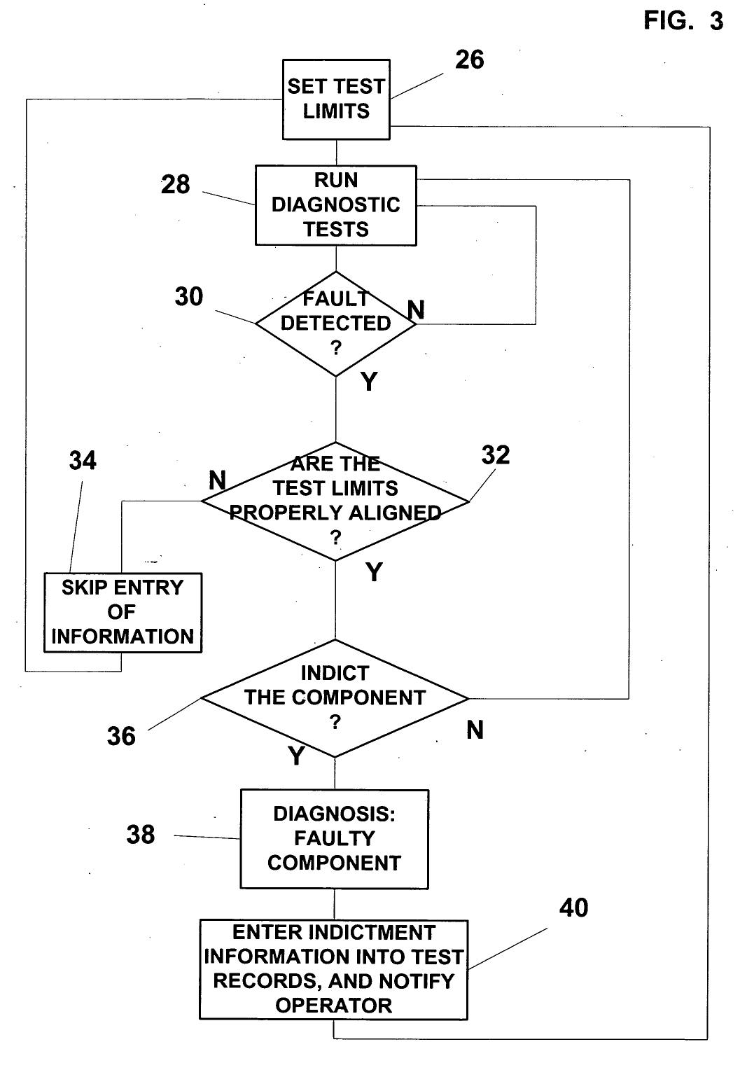

FIG. 3 is a flowchart showing a diagnostic testing procedure as per an embodiment of the invention. Test line limits are set (26). Then, the diagnostic tests are run (28), and it determined whether a faulty component has been detected (30). If no fault is detected, then the system can re-do the diagnostics (28) as scheduled, as directed by external commands, etc., and the equipment can return to its other functions.

If a fault is detected, then it is determined whether the fault detection is based on tests run with properly aligned test line limits (32). If not, then the test results showing the apparent fault are regarded as unreliable, and are not entered (34) into the test records. Also, no notification is given to the operator, that any component needs to be replaced.

If, for other reasons, it is deemed that the component does not need to be indicted (36), then the equipment again returns to its normal function, with additional diagnostic testing (28) as appropriate. If we will indict, then the diagnosis of a faulty component (38) is entered into the test records (40), and the operator is notified that a component will need to be replaced (40).

Although it may not be possible to perfectly normalize the test line limits for differing tests exercising some shared piece of failing hardware, it is desirable to get as close as possible. In an embodiment of the invention, this is done by defining the test line limit as being an optimal value or range of values, plus or minus a specified measurement uncertainty. This can be expressed mathematically by saying that, for a test line limit TLL, there shall be a measurement uncertainty MU. Then, if the measured value lies outside the range TLL+/−MU, the test result is set (34) to “Skip”. In an embodiment of the invention, any such skipped results are ignored in the fault diagnosis.

Some key test results are pointers to the general accuracy of the DUT. If, for example, one of the core stimulus signals is reading a little low, then this will have a large effect on many test results. Because these core signals are used in many of the tests, this may cause a large proportion of tests to be “skipped”.

In some cases when a core (i.e., critical or widely-used) stimulus signal has some known and reasonably small degradation, it has proven prudent to allow the use of results from some tests exercised by using these degraded signals. This is allowed because, although such critical tests use the stimulus signal in an absolute sense, some tests only use the signal to make relative measurements. This process is controlled by a combination of the tests, test logic and the test sequencer. To accommodate such allowance, some embodiments of the invention may provide functions which provide appropriate component coverage in each case.

Although the present invention has been described in detail with reference to particular embodiments, persons possessing ordinary skill in the art to which this invention pertains will appreciate that various modifications and enhancements may be made without departing from the spirit and scope of the claims that follow.

1. A self-contained embedded diagnostic method for performing a diagnostic test on a piece of equipment, the piece of equipment including a plurality of components and defining various pathways through respective subsets of the plurality of components, the method comprising:
setting test line limits;
performing the diagnostic test and obtaining test results;
determining whether the test results fall within the test limits; and
when the test results fall outside the test limits:
(1) determining whether the test limits are aligned; and
(2) if not, then disregarding the test results.

2. A method as recited in claim 1, further comprising storing a record of the test results if the determining includes determining that the test results fall within the test line limits.

3. A self-contained embedded calibration method for calibrating a piece of equipment against a set of performance specifications, the piece of equipment including a plurality of components and defining various pathways through respective subsets of the plurality of components, the method comprising:
operating the piece of equipment and obtaining results;
determining whether the results fall within the set of performance specifications;
when the results fall within the set of performance specifications, calibrating the piece of equipment by aligning the piece of equipment based on the results; and
when the results fall outside the set of performance specifications:
(1) determining whether the set of performance specifications is aligned; and
(2) if not, then disregarding the results.

4. A method as recited in claim 3, further comprising storing a record of the results if the determining includes determining that the results fall within the set of performance specifications.

5. A method as recited in claim 1, wherein the piece of equipment includes a piece of test and measurement equipment.

6. A method as recited in claim 3, wherein the piece of equipment includes a piece of test and measurement equipment.

7. A piece of equipment comprising:
a plurality of components and various pathways through respective subsets of the plurality of components; and:
program software for performing a self-contained embedded diagnostic test procedure including:
setting test line limits;
performing a diagnostic test and obtaining test results;
determining whether the test results fall within the test limits; and
when the test results fall outside the test limits:
(1) determining whether the test limits are aligned; and
(2) if not, then disregarding the test results.

8. A piece of equipment comprising:
a plurality of components and various pathways through respective subsets of the plurality of components; and:
program software for performing a self-contained embedded calibration procedure including:
operating the piece of equipment and obtaining results;
determining whether the results fall within the set of performance specifications;
when the results fall within the set of performance specifications, calibrating the piece of equipment by aligning the piece of equipment based on the results; and
when the results fall outside the set of performance specifications:
(1) determining whether the set of performance specifications is aligned; and
(2) if not, then disregarding the results.
